(19) United States
(12) Patent Application Publication
(10) Pub. No.: US 2011/0027044 A1
(43) Pub. Date: Feb. 3, 2011

(54) Tamper-proof nut or bolt head security cover

(76) Inventor: Eric John Dillenberger, Klamath Falls, OR (US)

Correspondence Address: William C. Fuess;Attorney at Law, Suite 2G, 10951 Sorrento Valley Road, San Diego, CA, 92121-1613, US

(21) Appl. No.: 12/462,139

(22) Filed: Jul. 29, 2009

(51) Int. Cl. F16B 37/14

(52) U.S. Cl. 411/372.5; 411/372.6

(57) ABSTRACT

In a security cover, or system, for a fastener both (1) a step washer, and (2) a hollow cylinder rotating to the contained step washer, are affixed to a surface by a nut, or by a bolt head, that is to be protected from tampering. A (3) hollow cap fits loosely over the bolt head or nut, and is either (A) compressively forced upon the step washer, the cap being within cylinder that is then rotatable relative to the cap, step washer and nut or bolt head; or else (B) compressively forced into the hollow of the cylinder, therein to rotate together with the cylinder relative to the step washer and nut or bolt head. The (3) hollow cap may also be fit compressively over, as opposed to within, the cylinder. No matter to which component the cap fits compressively, and whether mounted to the interior or exterior of the cylinder, the outermost structure—normally the cylinder—(A) rotates freely to the bolt head or nut contained therein, (B) is, by action of the lock washer, highly resistant to becoming compressed so as to gain purchase on the enclosed bolt head or nut for malicious loosening and tampering, and (C) is, by its compression fit, highly resistant to removal. An optional (4) ring can be fit between the cap and the cylinder and into complimentary circumferential grooves on each. The rotating incompressible cover in three, or in four, parts provides permanent, unremovable, security to a bolt head, or a nut, from tampering.

### BACKGROUND OF THE INVENTION

1. Field of the Invention

The present invention generally concerns tamper-resistant and tamper-proof fasteners.

The present invention particularly concerns a tamper-resistant and tamper-proof cover for a nut, for the head of a bolt, and for other features of threaded fasteners to which, when protruding above a plane during use of the fastener, a purchase may be gained for turning and loosening the fastener otherwise than that said cover be present.

2. Background of the Invention

2.1 Tamper-Resistant Nuts and Bolts

In the entry “Screw” from Wikipedia, the free encyclopedia of the web, it is reported circa 2009 as regards tamper-resistant screws that “[t]he general theory of tamper-resistant fasteners is to make a fastener whose loosening requires a tool that a tamperer is unlikely to have on hand at the time of opportunity for tampering. There is no expectation that it will be impossible for a tamperer to obtain the driver. Rather, the main idea is simply that most tamperers will not bother to seek out and obtain a driver. In the case of end-users, this reduces the incidence of do-it-yourself repair or modifications (and any resulting injury or product damage). In the cases of vandalism prevention and theft prevention, since most vandalism and theft incidents are simply crimes of easy opportunity, the idea is to “raise the bar” and make the opportunity less convenient.”

This comports with the philosophy, and meaning, of “tamper-resistant” in the present specification. However, tamper-resistant fasteners in accordance with the present invention will be seen to be extremely difficult fo remove for more than just a lack of a specific tool, the fasteners essentially being tightened independently of, and before the placement of, a final security cover that, once placed, makes the fastener all but impossible to remove with any tool that can be envisioned, no matter whether common or custom. The fastener security system in accordance with the present invention will thus be seen to be very close to tamper proof. The turned and tightened elements of the fastener system of the present invention will be seen to essentially become permanently inaccessible, which concept may be held in mind as the prior art—which basically only obstructs turning but does not totally preclude it—is further reviewed.

One type of tamper-resistant screws is the protruding obstacle head, including the “[t]amper-resistant external-TORX driver”. Many screw drives, including Phillips, Torx, and hex socket, have tamper-resistant variants. These typically have a pin protruding in the center of the screw head, necessitating a special tool for extraction. In some variants the pin is placed slightly off-center, requiring a correspondingly shaped bit. However, the bits for many tamper-resistant screw heads are now readily available from hardware stores, tool suppliers and through the Internet. There are also many commonly used techniques to extract tamper resistant screws without the correct driver—for example, the use of an alternative driver that can achieve enough grip to turn the screw, modifying the head to accept an alternative driver, forming one's own driver by melting an object into the head to mold a driver, or simply turning the screw using a pair of locking pliers. Thus, these special screws offer only modest “security. However, it is often enough to discourage the more mindless varieties of vandalism.”

Another type is the “One-way only head [where a] [o]ne-way slotted screw. The slotted screw drive also comes in a tamper-resistant one-way design with sloped edges; the screw can be driven in, but the bit slips out in the reverse direction.”

There are also various “[p]roprietary heads . . . with unusual, proprietary head designs, featuring matching drivers available only from them, and only supplied to registered owners. These tend to be confined to industrial uses that the average layperson does not have contact with. But one example familiar to lay persons is the attachment for the wheels and/or spare tires of some types of car; one of the nuts may require a specialized socket (provided with the car) to prevent theft.”

Finally, there is the “[b]reakaway head . . . [or] bolt [that] is a high-security fastener that is extremely difficult to remove. It consists of a counter-sunk flat head screw, with a thin shaft and hex head protruding from the flat head. The hex head is used to drive the bolt into the countersunk hole, then the wrench or hammer is used to knock the shaft and hex head off of the flat head, leaving only a smooth screw head exposed. Removal is facilitated by drilling a small hole part way into the outer part of the head and using a broken-screw extractor (“easy-out”) or a punch and hammer at a sharp angle in a counter-clockwise direction. This type of screw is used primarily in prison door locks.”

### SUMMARY OF THE INVENTION

The present invention contemplates a tamper-proof security cover for a nut, for the head of a bolt or of a screw, or for any fastener having, when deployed, at least a portion protruding above a surface to the side or sides of which portion a purchase may be had. Such a purchase—no matter how difficult or special—permits that the fastener may be loosened and removed. The present invention further contemplates a fastener such as a bolt and nut where that part of the fastener protruding above a surface—such as, for example, the nut threading the shaft of the bolt, or the head of the bolt of said bolt and nut fastener—is permanently affixed with one system component: (1) a tamper-proof cover. This (1) cover interacts with two other system components—(2) a hollow cylinder with an end annular surface, and (3) a step washer—that are held by the fastener—i.e., by the nut or the bolt—so that the (1) cover may not be removed.

The security system of the present invention is more tamper-proof than tamper resistant, being substantially permanent and unremovable save that the entire fastener be destroyed in situ by flame cutting, abrasive grinding or like extreme forces and operations that are most often very slow, difficult and/or expensive to accomplish. Particularly when applied to a nut on a shaft, or to the head of a bolt, of ⅜ inch or greater diameter, the security cover of the present invention is all but impossible to remove with hand tools of any nature. Removal may be still further impeded by recessing the nut, or the bolt head, within a surface cavity of the structure that it serves to secure.

The present invention has general applicability for realizing secure, permanent, and tamper-proof fasteners, but is perceived to be especially useful in securing solar panels in the out-of-doors, where the tamper-proof nature of the fastener and fastener cover are—particularly as preferably economically fabricated in stainless steel—are each of effective to prevent theft of the solar panels, esthetically appealing, non-corroding and durable for decades.

### 1. The Essential Nature of the Tamper-Proof Security Cover of the Present Invention

In simplest terms, the present invention adds but three (3) components to, by way of example, the exemplary common nut and bolt fastener. These three components are: (1) a hollow cylinder with an annulus at one end, or simply “cylinder”; (2) a step washer, and (3) a cap—all as are later explained.

These three (3) components are added (A) upon all sides of and completely about the nut (and any shaft threaded by the nut) if that is the part of the nut and bolt that protrudes above a surface, or, alternatively, (B) upon all sides of and completely about the head of the bolt if that is the part of the nut and bolt that protrudes above the surface. Two (2) of these three (3) components—the cylinder and the step washer—are fitted between the nut, or the bolt head, and the surface. One (1) of these three (3) components—the cap—is fitted over either one—the step washer—or both—the step washer and the cylinder—of the other two (2) components, and always over the nut (and the shaft threaded by the nut), or the bolt head, as the case may be.

The first of the three components is, in simple terms, a hollow cylinder having and presenting an annular surface upon a one end. The cylinder is sized and shaped to be both of greater diameter, and greater height, than is the nut, or bolt head. Further, the opening of the cylinder's annular surface is of greater diameter than is the shaft of the bolt, or the shaft that is threaded by the nut, as the case may be. In accordance that the central opening of this annular surface is preferably a good deal, nominally 25% or more, larger in diameter than is the shaft of the bolt, or the shaft that is threaded by the nut (as the case may be), that is enclosed by this hollow cylinder, this first component starts out rather loose, and free to turn, about the threaded shaft. It sometimes called a “free turning housing”, and sometimes simply a “cylinder”. As will shortly be explained, this “free turning housing” remains free to turn throughout the assembly, and deployment, of the tamper-proof security cover of the present invention.

The second component is a “step washer”, being defined as one or more flat washers where a first washer, or washer portion, is of a first, relatively lessor, exterior diameter while a second washer, or washer portion, is of a second, relatively greater, exterior diameter. The interior bore(s) to all portions of this second, “step washer”, component is (are) commonly (but not absolutely necessarily) uniform, meaning that there is effectively but one single central bore, and this central bore is of appropriate size to slip the shaft of the bolt, or the shaft that is threaded by the nut (as the case may be). This second, “step washer”, component is preferably integrally formed as one single washer having the first, relatively lessor, exterior diameter at its first side surface and having the second, relatively greater, exterior diameter at its opposite second side surface. The single washer thus presents a shoulder, or “step”, in and between its two exterior diameters, and is thus called a “step washer”. That portion of the “step washer” that is of lessor exterior diameter is if greater thickness than is the annular ring of the first component, or “free turning housing”.

During installation assembly of the first and the second components upon a threaded shaft (to which will be affixed a nut) protruding through a surface, the “free turning housing” is first positioned with its annular portion about the shaft and adjacent the surface, and then the “step washer” is also placed upon the shaft, and within the hollow cylinder of the “free turning housing”, so that its portion of lessor diameter is oriented towards the surface, and within the central bore of the annulus of the “free turning housing”. Equivalently, in use with a bolt, the “free-turning housing” is closest to the surface, and the greater-diameter portion of the “step washer” is closest tp the head of the bolt, as both the “free-turning housing” and the “step washer” fit upon the shaft of the bolt between the bolt's head and the surface. The nut, or the bolt—as the case may be—is then tightened securely, leaving the “free turning housing” free to turn between the nut, or the head of the bolt (as the case may be) and the surface. This “free turning” about the threaded shaft aptly suits the very name of this component.

The final component is a press fit, or a slip fit, “cap”. This “cap” comes in two embodiments, the first of which has two variants. In it's most preferred variant of its most preferred embodiment the “cap” is in the form of (1) a cylinder with a cylindrical wall of exterior diameter less than is the interior diameter of the hollow cylinder of the “free turning housing” and of interior diameter sufficiently large so as to enclose the nut, or the head of the bolt (as the case may be) and tightly fit over the larger-diameter portion of the step washer, with (2) a closed circular surface at one end of the cylinder. As will be seen in the second following paragraph, this means that the “cap”. compressively affixes the “step washer” (which is itself affixed below the tightened nut, or bolt head (as the case may be), and is thus unmoving.

In it's less preferred variant still of this first embodiment the “cap” is the same save that its exterior diameter is but slightly less than is the interior diameter of the hollow cylinder of the “free turning housing” while its interior diameter does loosely the larger-diameter portion of the step washer. As will be seen in the next following paragraph, this means that the “cap” compressively affixes the “free turning housing”, and thus moves in rotation with the “free turning housing”.

Notably, in both these variants of the first embodiment of the “cap”, the cap fits within the cylinder. The difference in the variants is, as just explained, whether the cap (A) tightly slips over the step washer but fits but loosely within the cylinder, or (B) slips loosely over the step washer but is tight to the interior of the cylinder. In a second, less preferred, embodiment the cap fits over, and not within, the cylinder. There are no “variants” to this second embodiment, the cap clinches tight to the cylinder over which it fits.

During final installation assembly, any embodiment of “cap” is (1) slipped within the hollow cylinder of the “free turning housing”, (2) slipped over the nut or bolt head (as the case may be) that is then-contained by the free-turning housing. Further, in its preferred first variant first embodiment the cap is (3a) tightly pressed over and upon (at least) the greater, first, diameter portion of the “step washer”, or, in its second variant first embodiment (3b) tightly pressed within the “free turning housing” (and also, simultaneously, loosely over the greater, first, diameter of the “step washer”. Thus the first embodiment of the “cap” is always shaped and sized so as to completely or substantially completely fit within the open end, and the exposed cylindrical side surface, of the free-turning housing within which it fits. However, (1) in its first variant of its first embodiment the “cap” will tightly engage the “step washer” in this position, and will remain immobile, while (2) in its second variant of this first embodiment the “cap” will tightly engage the “free turning housing” and will rotate with this “free turning housing”.

In its less preferred first second embodiment the cap is (3c) tightly pressed over and upon (at least) the “free turning housing”, and thereafter rotates therewith.

These two embodiments—one with two variants—of the cap may, and what fits tight to, or loose to, what may initially seem complex. However, the underlying idea common to all embodiments and variants is straightforward. An outmost cap, or cylinder (as the case may be), both (1) overlies, and contains, and protects the underlying nut, or bolt head, and (2) freely rotates without imparting any torque whatsoever to this contained nut or bolt head (as the case may be). Moreover, once assembled the three components are not readily disassembled.

So configured and assembled the tamper-proof nut or bolt head cover of the present invention presents, in its mounted position under the nut, or bolt head (as the case may be), only the following portions of the following components: (1) the exterior cylindrical wall of the “free turning housing” forms a readily rotatable open-topped cylinder extending from the surface to which the nut and bolt is affixed, while (2) the closed circular surface of the “cap” fits—either tightly or no—either within, or over, that (open) end of the “free turning housing” that is opposite to the end near to the surface. In the first variant of the first embodiment of the cap, the (1) entire “free turning housing” rotates about (2) the contained “cap”, which remains fixed. In the second variant of the first embodiment of the cap, the (1) entire “free turning housing” and the contained cap rotate together. In the second embodiment of the cap, the (1) entire “free turning housing” and the (2) cap—no longer contained, but now outside the “free turning housing”—rotate together.

The difference is of no great consequence. The nut and any end of the threaded shaft, or the bolt head (as the case may be), is (are) completely contained, or encapsulated, within the fixed or rotating “cap” and the rotating “free turning housing”.

This containment, or encapsulation, in accordance with the present invention is secure, and tamper-proof. There is no ready way to get either embodiment of the “cap” separated from its pressed affixation to the “step washer” or the “free turning housing”. Likewise, there is no ready way to get the “free turning housing” from under the step washer (as this step washer is secured by the nut, or by the head of a bolt).

There is no way to access the nut, or the bolt head (as the case may be) for turning, being that this element is completely surrounded and protected by the “cap” in combination with the “free turning housing”. Squeezing the entire cover with great force does little but force the “free turning housing” against the “cap”, which “cap” is already against the “step washer” which is about and upon the threaded shaft, and which can typically withstand huge compressive forces.

Likewise, there is no easy way to remove the “cap” from off the “step washer” because the “cap” is protected, including from prying forces, by a properly sized and positioned “free turning housing”.

Finally, any attempt to abrade or cut off the entire secure cover rotary grinding, such as with a file or an abrasive cutting wheel, is aggravated by the rotation of the “free turning housing”.

In summary, once his security cover is installed the inventor knows of no good way to remove it, nor any way at all using but simple hand tools whether common or custom.

### 2. A Tamper-Proof Security Cover with a First Variant First Embodiment “Cap”

Accordingly, in one of its aspects the present invention is embodied in a tamper-proof security cover for the head of a bolt, or for a nut threading a threaded shaft, as the bolt or the nut (as the case may be) becomes tightened to a surface.

The security cover includes a walled hollow cylinder (1) having an internal diameter greater than is an imaginary circle circumscribing the head of the bolt of the nut and (2) having a greater length along an imaginary central axis than is the head of the bolt, or the nut plus any shaft that is threaded by the nut, as the case may be, as such bolt of nut and shaft protrude above the surface when tightened thereto. This walled hollow cylinder is (3) partially occluded at one end by an integral annular ring having a circular central aperture of greater diameter than is a shaft of the bolt, or the shaft threaded by the nut, as the case may be.

The cover further includes a step washer having (1) a first portion that is of an interior diameter suitable to pass the shaft of the bolt, or the shaft threaded by the nut, as the case may be, and a first, relatively smaller, exterior diameter that is complimentary to the annulus of the annular ring of the walled hollow cylinder and thicker than is this annular ring. This step washer further has (2) an integral second portion that is of an interior diameter again suitable to pass the shaft of the bolt, or the shaft threaded by the nut, as the case may be, and a second, relatively greater, exterior diameter that is complimentary to the interior diameter of the walled hollow cylinder.

This walled hollow cylinder, and this the step washer, are disposed about the nut or bolt (as the case may be) so that (1) the walled hollow cylinder is first placed upon the shaft that is threaded by the nut, or upon the shaft of the bolt, as the case may be, so that its annular ring is towards the surface, then (2) the step washer is next, second, placed upon the shaft that is threaded by the nut, or upon the shaft of the bolt, as the case may be, so that its first portion fits within the central circular aperture of the annulus of the annular ring of the walled hollow cylinder while its second portion retains the walled hollow cylinder between itself and the surface, and (3) the nut is first threaded upon the shaft, or the shaft of the bolt placed though the step washer and the walled hollow cylinder and its aperture, as the case may be, and then securely tightened, leaving the walled hollow cylinder securely retained but nonetheless free to rotate about the shaft of the bolt, or the shaft to which the nut is threaded, as the case may be/

The cover still further, and finally, includes a hollow closed-end cylindrical cap with an internal diameter that is tight to the greater external diameter of the step washer, and with an external diameter that is snug to the interior diameter of the walled hollow cylinder.

When the hollow closed-end cylindrical cap is pressed over and upon the step washer, leaving that the walled hollow cylinder remains free-turning, then the cap becomes fixed nonetheless that its closed end, and the free-turning walled hollow cylinder, completely surround and encapsulate regions of the nut and thread shaft, or the bolt head (as the case may be) otherwise exposed above the surface. This combination of the walled hollow cylinder, the step washer and the hollow closed-end cylindrical cap serves to protect the nut, or the bolt, from being tampered with.

### 3. A Tamper-Proof Security Cover with a Second Variant First Embodiment “Cap”

Further accordingly, the present invention may still be embodied as a tamper-proof security cover for the head of a bolt, or for a nut threading a threaded shaft, as the bolt or the nut (as the case may be) becomes tightened to a surface, with all components being the same in this embodiment as before, save only that the cap is slightly differently sized.

In this, second, embodiment of the cover, the cover still includes a hollow closed-end cylindrical cap. However, this cap now has an internal diameter that is loose to the greater external diameter of the step washer, and an external diameter that is tight to the interior diameter of the walled hollow cylinder.

When this second embodiment of hollow closed-end cylindrical cap is pressed within the walled hollow cylinder, and over and upon the step washer, it will again leave the walled hollow cylinder to be free-turning. However, now the cap will no longer be fixed as within the first embodiment, but will turn with free-turning walled hollow cylinder. However, as before, these two components of the free-turning hollow cylinder, and the cap, in combination completely surround and encapsulate regions of the nut and thread shaft, or the bolt head (as the case may be) that is otherwise exposed above the surface. This combination of the walled hollow cylinder, the step washer and the hollow closed-end cylindrical cap, again serves to protect the nut, or the bolt, from being tampered with.

### 4. Enhancements to the Rudimentary, Three-Piece, Embodiment of the Fastener Security System of the Present Invention

It is possible to further improve the security system of the present invention by (1) modifying the external contours of the cap, or the internal contours of the hollow cylinder, or both, including with (2) optionally adding a fourth component.

The cap may have a lip at its lower opening, and the hollow cylinder a complimentary interior lip. The cap is temporarily circumferentially compressed during insertion into the hollow of the cylinder, a process that is preferably aided by the presence of longitudinal slots within the cap. After insertion the cap springs back so that its exterior rim engages the interior lip of the cylinder, and extraction of the cap from the cylinder becomes impossible.

Alternatively, both the exterior circumference of the cap, and the interior circumference of the cylinder, may both be circumferentially grooved, and a fourth component—a ring like as to the compression ring on the cylinder of a reciprocating internal combustion engine—may be fit between them. The ring engages both grooves, and again renders extraction of the cap from the cylinder impossible.

### 5. The Philosophy of the Invention

Although the number of parts within the fastener security system of the present invention is but a modest three or, with enhancements, four, the dimensional relationships between these parts, and their functional interaction, makes that a reader first trying to understand the invention becomes “lost in the forest for the trees”. It is believed that, in its underlying concept and philosophy, something wholly new is going on in and with the security system of the present invention. This “something” is quite simple. The fastener that is being protected—the nut, or the bolt, or whatever—is completely conventional. During use it is employed at its full strength to strongly affix two components of the security system of the present invention: the (1) hollow cylinder with annular end surface, or housing, plus (2) the step washer. Then at least the remaining component of the (3) cap, and possibly also a (4) ring, is (are) permanently mounted to the first two components so as to prevent access to the fastener.

The fastener thus captures, and retains, its own security system, which security system does not simply impede that the fastener should be loosened (such as by use of special tools), but substantially precludes that the fastener should ever be so loosened.

### 6. A Tamper-Proof Security Cover

Therefore, in but one of its many aspects and configurations, the present invention will be recognized to be embodied in a tamper-proof security system for the head of a bolt, or of a nut threading a threaded shaft, as the bolt or the nut becomes tightened to a surface.

One security cover includes (1) a walled hollow cylinder with an annulus at a one end, and (2) a step washer of greater diameter in a first side portion and of lesser diameter in a second side portion. In use the lesser diameter portion of the step washer fits within the annulus of the cylinder when both fit over a threaded shaft passing through a surface, annulus towards the surface and between the surface and a nut, or the head of a bolt—as the case may be—so that the nut or bolt head captures the step washer tight, but the cylinder so as to rotate, to the surface.

Finally, (3) a hollow cap that fits tightly either over, or within, the cylinder as captured to the surface so as to rotate therewith while covering the nut, or the head of the bolt—as the case may be.

By this construction, and this coaction, any attempt to bring strong compressive forces to bear so as to squeeze both the hollow cap and the hollow cylinder against the nut, or the head of the bolt—as the case may be—so that, prospectively, the nut or the bolt might be forcibly un-threaded is frustrated by the greater diameter portion of the step washer which holds walls of the cap and cylinder away from the covered nut or bolt head—as the case may be.

This tamper-proof security cover may optionally further include (4) an attachment between the cap and the cylinder for permanently engaging the same when the cap is fit tightly over, or within, the cylinder.

In the case wherein the (3) cap fits within the cylinder, has and presents an extending rim at its opening, and has and presents slots so that the diameter of said extending rim may be compressed during forcible insertion of the cap within the cylinder, the (4) attachment may then consist of an interior circumferential lip that is caught by the rim of the cap when the cap is forcibly inserted within the cylinder, the compressed cap rim springing back to a larger diameter upon passing the lip and thereafter retaining the cap to, and within, the cylinder.

In the case wherein the (3) cap fits over the cylinder, and has and presents an interior circumferential groove, and the (2) cylinder has and presents an exterior circumferential groove, then the (4) attachment can be a compressible ring fitting within the interior circumferential groove of the cap during its forcible placement over the cylinder so as to, when positioned oppositely to the exterior circumferential groove of the cylinder, pop into place within the grooves of both cap and cylinder, holding both together.

### 7. A Method of Protecting from Tampering a Nut or, Equivalently, a Bolt Head

In yet another of its aspects, the present invention is embodied in a method of protecting from tampering a nut or, equivalently, a bolt head appearing above a surface/

The method includes fitting between the nut or bolt head—as the case may be—and the surface both (1) a step washer with a side region of larger diameter towards the surface, and (2) a hollow cylinder with an annulus at one end captured so as to rotate by the step washer, and with its sidewall extending away from the surface. Then the nut, or equivalently the bolt, is tightened so as to leave the hollow cylinder captured by the step washer in a manner by which it may rotate, with the sidewall of the hollow cylinder enclosing all sides of the nut or bolt head—as the case may be.

Next a hollow cap is forcibly tightly compressed either into or, equivalently, over the sidewall of the hollow cylinder so as to (1) thereafter rotate therewith, while (2) covering the nut, or the bolt head, as the case may be so as to thereafter prevent that the nut, or the bolt, should be loosened.

These and other aspects and attributes of the present invention will become increasingly clear upon reference to the following drawings and accompanying specification.

### BRIEF DESCRIPTION OF THE DRAWINGS

FIG. 1a is an exploded perspective view showing a complex, four-component-part, and most-secure, embodiment of the security cover of the present invention as deployed to protect a nut that is threaded to a shaft.

FIG. 1b is an exploded perspective view, like as to FIG. 1b, of a rudimentary, three-component-part, still-secure, embodiment of the security cover of the present invention as deployed to protect the head of a bolt.

FIG. 2, consisting of FIGS. 2a and 2b, are cut-away plan views of two alternative embodiments of the cap and the cylinder (or housing) that are two component parts of the security cover of the present invention.

FIG. 3 is an exploded perspective view of a variant embodiment of the security cover of the present invention previously seen in FIG. 1b now shown in a particular deployed use to secure two nuts of the mounting of a solar panel, or module.

### DESCRIPTION OF THE PREFERRED EMBODIMENT

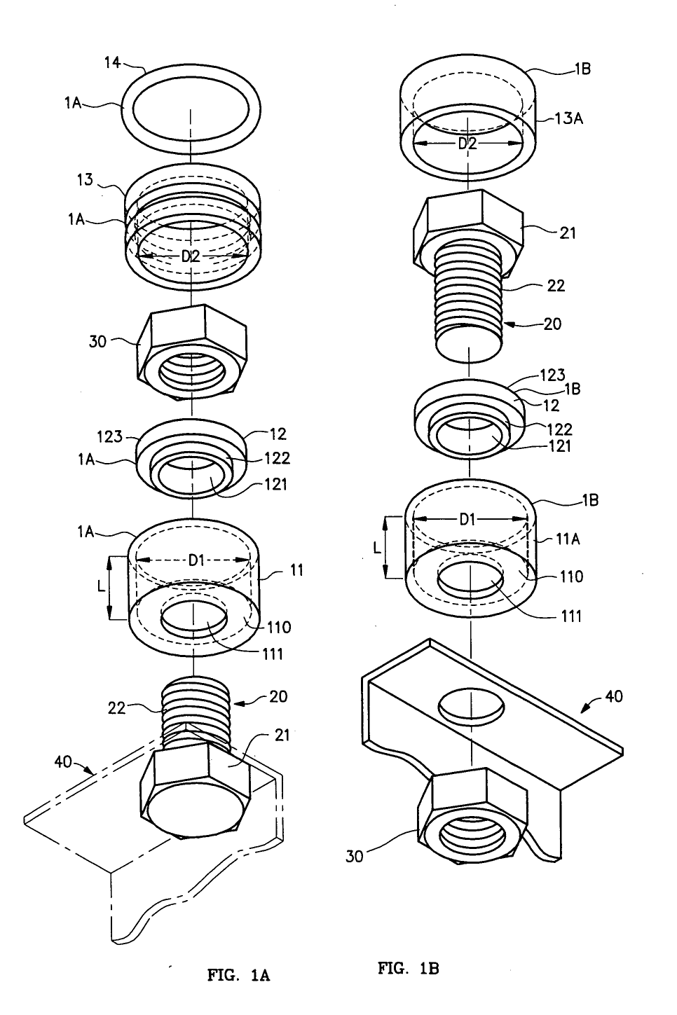

Two embodiments of the security cover of the present invention deployed to protect a nut that is threaded to a shaft, and deployed to protect the head of a bolt (holding, by way of example, a solar panel) are respectively shown in exploded perspective view in FIGS. 1a and 1b.

FIGS. 1a and 1b respectively show a first, four-component-part and a second, three-component-part, embodiment of a tamper-proof security cover 1 in accordance with the present invention. The four component parts of the first embodiment of FIG. 1a are the walled hollow cylinder, or housing, 11; the step washer 12; the cap 13; and the ring 14. The three component parts of the second embodiment of FIG. 1b are the walled hollow cylinder, or housing, 11A; the step washer 12; and the cap 13A, the ring 14 being omitted.

The view of FIG. 1a shows a nut 30 threading a threaded shaft 22 of a bolt 20, and the view of FIG. 1b equivalently shows the head 21 of the bolt 20, as the bolt 20 and nut 30 become tightened to, and about, a surface 40. The bolt 20, nut 30 and surface 40 are not part of the present invention of the cover 1 (having three or four parts immediately next discussed in the following paragraphs), and are correspondingly illustrated in phantom line.

A washer of the conventional or locking type (not shown) may in all cases be used for conventional reasons on the shaft 22 immediately next to the nut 30, or the bolt head 21, or both. When the pieces and the function of the cover 1 of the present invention become better understood the concept of using a washer of washers may be reviewed by imaging their inclusion in FIG. 1, and it may be understood that they will not interfere with the use of the cover 1 to provide security.

Commencing now with the structure of the actual present invention of the cover 1, this cover 1 includes a walled hollow cylinder 11, 11A. This cylinder 11, 11A has an internal diameter D1 greater than is an imaginary circle (not shown) circumscribing the head 21 of the bolt 20, or the nut 30, as the case may be (determined by which such element the cylinder 11, 11A must fit over, of course). This cylinder 11, 11A further has a greater length L along an imaginary central axis (not shown) than is the thickness of the nut 30 plus excess extension of the shaft 22 that is threaded by this nut 30 (as in FIG. 1a), or the head 21 of the bolt 20 (as shown in FIG. 1b), as the case may be. This is simply to say the cylinder 11, 11A will cover that portion of any fastener which protrudes above the surface 40 when ultimately tightened thereto. This cylinder 11, 11A is partially occluded at one end by an integral annular ring 110 having a circular central aperture 111 of greater diameter than is a shaft 22 of the bolt 20 (as in FIG. 1b), or the shaft 22 as is threaded by the nut 30 (as in FIG. 1a), as the case may be.

The cover 1 further includes a step washer 12. This step washer 12 has (1) a first portion 122 that has a bore 121 of a diameter suitable to pass the shaft 22 of the bolt 20 (as shown in FIG. 1b), or the shaft 22 threaded by the nut 30 (as shown in FIG. 1a), as the case may be, and (2) a first, relatively smaller, exterior diameter that is (2a) complimentary to the annulus 111 of the annular ring 110 of the walled hollow cylinder 11, and (2b) thicker than is this annular ring 110. This step washer has a preferably integral second portion 123 that again has the bore 121 of sufficient diameter again suitable to pass the shaft 22 of the bolt 20 (as in FIG. 1b), or the shaft 22 threaded by the nut 30 (as in FIG. 1a), as the case may be. Finally, this second portion 123 of the step washer 11 has a second, relatively greater, exterior diameter that is complimentary to the interior diameter D1 of the walled hollow cylinder 11. “Complimentary to” means that the step washer 11 fits within the hollow cylinder 11, and how tightly of loosely it may do so is later discussed.

In assembly, the walled hollow cylinder 11, the step washer 12, and the nut 30 or bolt 20 are disposed so that the walled hollow cylinder 11, 11A is first placed upon the shaft 22 that is threaded by the nut 30, or upon the shaft 22 of the bolt 20, as the case may be, so that its annular ring 111 is towards the surface 40. Then the step washer 12 is next, second, placed upon the shaft 22 that is threaded by the nut 30, or upon the shaft 22 of the bolt 30, as the case may be, so that its first portion 121 fits within the central circular aperture, or annulus, 111 of the annular ring 110 of the walled hollow cylinder 11, 11A while its second portion 123 retains the walled hollow cylinder 11, 11A between the step washer 12 itself and the surface 40. The nut 30 is first threaded upon the shaft 22, or the shaft 22 of the bolt 20 placed though the step washer 12 and the walled hollow cylinder 11 and its aperture 111, as the case may be, and then securely tightened, leaving the walled hollow cylinder 11 securely retained but nonetheless free to rotate about the shaft 22 of the bolt 20, or the shaft 22 to which the nut 30 is threaded, as the case may be.

The cover 1 further includes a hollow closed-end cylindrical cap 13, 13A with an internal diameter D2 that is tight of loose to (1) the largest external diameter of the step washer 12, or (2) the internal diameter D1 of the walled hollow cylinder 11, 11A, either or both in any combination as will be discussed. Most preferably the closed-end cylindrical cap 13, 13A of internal diameter D2 is tight to one, any only one, of (1) the largest external diameter of the step washer 12, or (2) the internal diameter D1 of the walled hollow cylinder 11, and strongly preferably this closed-end cylindrical cap 13, 13A (of internal diameter D2) is not simultaneously tight to both (1) the largest external diameter of the step washer 12, and (2) the internal diameter D1 of the walled hollow cylinder 11, 11A

In final assembly this hollow closed-end cylindrical cap 13, 13A is pressed over and upon the walled hollow cylinder 11 that may be, and preferably is, now free-turning, making that the cap 13, 13A becomes free-turning also nonetheless that the head 21 of the bolt 20, or the nut 30 and shaft 22 threaded by the nut 30, are surrounded where protruding above the surface 40.

In combination, the walled hollow cylinder 11, 11A the step washer 12 and the hollow closed-end cylindrical cap 13, 13A serve to protect the nut 30, or the head 21 bolt 20, from being tampered with. Notably the cylinder 11 can, and most often does, have a sufficiently large interior diameter so as to permit passage of a (preferably) thin-walled socket (not shown) for the tightening of the nut 30, or the bolt head 21.

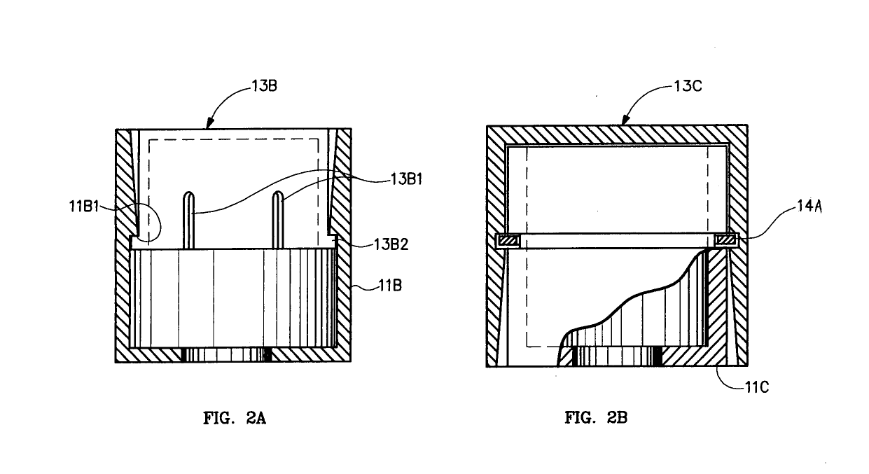

The first embodiment of FIG. 1a also shows a ring 14, which ultimately fits between the cap 13 and the cylinder 11 (like as to the fit between cap 13C and cylinder 11C as will next be shown in FIG. 2b). The ring 14 can be an elastomer O″-ring. This is, of course, good for sealing weather tight the cover. However, another variant of the ring 14 providing mechanical strength will be shown in FIG. 2b.

Cut-away detail plan views of two of a further alternative embodiments of a cap 13B and complementary cylinder 11B, and of a cap 13C and a complimentary cylinder 11C, are shown in FIGS. 2a and 2b.

The cap 13B shown in FIG. 2a has slots 13a1, 13a2 (illustrated) . . . 13aN (etc.) in its exterior surface. The cap 13B gas a lip 13B2 at its lower opening. The hollow cylinder 11B has a complimentary interior lip 11B1. The cap 13B is temporarily circumferentially compressed during insertion into the hollow of the cylinder 11B, a process that is preferably aided by the presence of longitudinal slots 13B1 within the cap 13B. After insertion the cap 13B springs back so that its exterior rim 13B2 engages the interior lip 11B1 of the cylinder 11B, and extraction of the cap 13B from the cylinder 11B becomes impossible.

Alternatively, as shown in FIG. 2b, (1) the relative sizes, and fittings, of cap and cylinder may be interchanged, while (2) both the interior circumference of the cap 13C, and the exterior circumference of the cylinder 11C, may both be circumferentially grooved, and a fourth component—a ring 14A like as to the metal compression ring on the cylinder of a reciprocating internal combustion engine—may be fit between them. The ring 14A engages the grooves of both cap 13C and cylinder 11C, and again renders extraction of the cap 13C from over the cylinder 11C impossible.

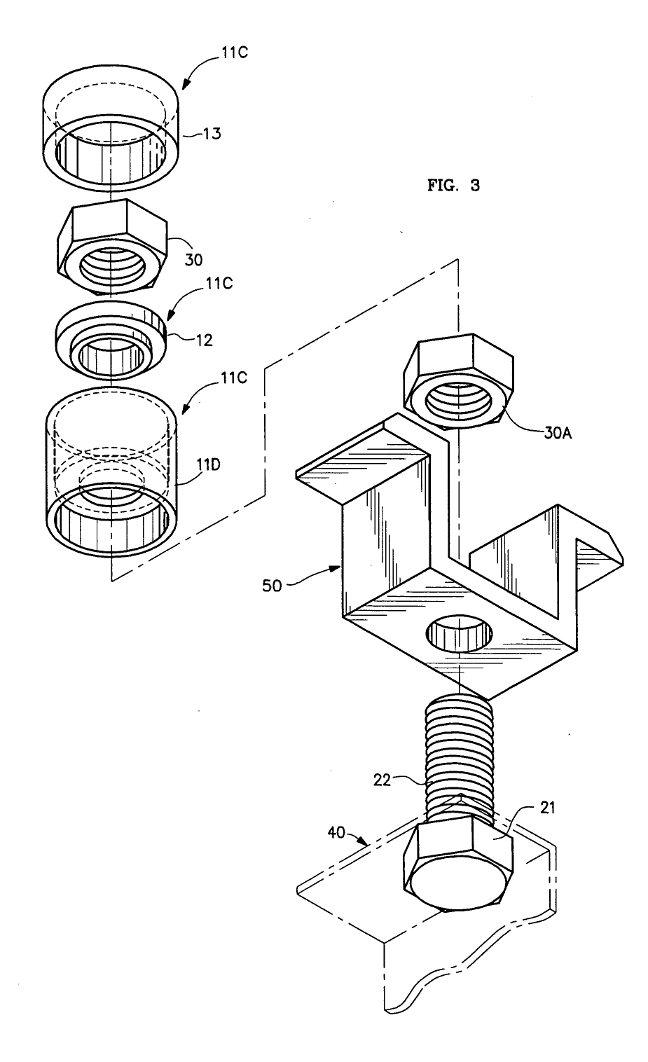

FIG. 3 is exploded perspective view of a same, most preferred, embodiment of the security cover of the present invention previously seen in FIG. 1, and particularly in FIG. 1b. The cover is in use to secure a solar panel, or module, 50, or, alternatively, a clamp 50 that is itself used to retain a solar panel, or module, 50. Two nuts 30A and 30B are illustrated as being simultaneously protected. This common use of the security cover 1 of the present invention serves to protect high value solar panels, located outdoors, from theft.

In accordance with these variations, and still others readily realizable by a practitioner of the mechanical and fastener arts, the present invention should be considered in accordance with the following claims, only, and not solely on accordance with those embodiments within which the invention has been taught.

What is claimed is:

1. A tamper-proof security cover for the head of a bolt, or of a nut threading a threaded shaft, as the bolt or the nut becomes tightened to a surface, the cover comprising:
a walled hollow cylinder
having an internal diameter greater than is an imaginary circle circumscribing the head of the bolt of the nut and having a greater length along an imaginary central axis than is the head of the bolt, or the nut plus any shaft that is threaded by the nut, as the case may be, as will protrude above the surface when tightened thereto,
that is partially occluded at one end by an integral annular ring having a circular central aperture of greater diameter than is a shaft of the bolt, or the shaft threaded by the nut, as the case may be;
a step washer having
a first portion that is of an
interior diameter suitable to pass the shaft of the bolt, or the shaft threaded by the nut, as the case may be, and
a first, relatively smaller, exterior diameter that is
complimentary to the annulus of the annular ring of the walled hollow cylinder and
thicker than is this annular ring, and
an integral second portion that is of an
interior diameter again suitable to pass the shaft of the bolt, or the shaft threaded by the nut, as the case may be, and
a second, relatively greater, exterior diameter that is complimentary to the interior diameter of the walled hollow cylinder;
wherein the walled hollow cylinder, the step washer, and the nut or bolt are disposed so that
the walled hollow cylinder is first placed upon the shaft that is threaded by the nut, or upon the shaft of the bolt, as the case may be, so that its annular ring is towards the surface, then
the step washer is next, second, placed upon the shaft that is threaded by the nut, or upon the shaft of the bolt, as the case may be, so that its first portion fits within the central circular aperture of the annulus of the annular ring of the walled hollow cylinder while its second portion retains the walled hollow cylinder between itself and the surface, and,
the nut is first threaded upon the shaft, or the shaft of the bolt placed though the step washer and the walled hollow cylinder and its aperture, as the case may be, and then securely tightened, leaving the walled hollow cylinder securely retained but nonetheless free to rotate about the shaft of the bolt, or the shaft to which the nut is threaded, as the case may be; and
a hollow closed-end cylindrical cap with an internal diameter that is tight to the external diameter of the walled hollow cylinder;
wherein the hollow closed-end cylindrical cap is pressed over and upon the walled hollow cylinder that is now free-turning, making that the cap becomes free-turning also nonetheless that the head of the bolt, or the nut and shaft threaded by the nut, are surrounded where protruding above the surface;
wherein, in combination, the walled hollow cylinder and the step washer and the hollow closed-end cylindrical cap protect the nut, or the bolt, from being tampered with.

2. A tamper-proof security cover for the head of a bolt, or of a nut threading a threaded shaft, as the bolt or the nut becomes tightened to a surface, the cover comprising:
a walled hollow cylinder with an annulus at a one end;
a step washer of greater diameter in a first side portion and of lesser diameter in a second side portion;
wherein the lesser diameter portion of the step washer fits within the annulus of the cylinder when both fit over a threaded shaft passing through a surface, annulus towards the surface and between the surface and a nut, or the head of a bolt, as the case may be so that the nut or bolt head captures the step washer tight, but the cylinder so as to be capable of rotating, to the surface; and
a hollow cap that fits tightly either over, or within, the cylinder as captured to the surface so as to rotate therewith while covering the nut, or the head of the bolt, as the case may be;
wherein any attempt to bring strong compressive forces to bear so as to squeeze both the hollow cap and the hollow cylinder against the nut, or the head of the bolt, as the case may be so that, prospectively, the nut or the bolt might be forcibly un-threaded is frustrated by the greater diameter portion of the step washer which holds walls of the cap and cylinder away from the covered nut or bolt head, as the case may be.

3. The tamper-proof security cover according to claim 2 further comprising:
an attachment between the cap and the cylinder for permanently engaging the same when the cap is fit tightly over, or within, the cylinder.

4. The tamper-proof security cover according to claim 3
wherein the cap
fits within the cylinder,
has and presents an extending rim at its opening, and
has and presents slots so that the diameter of said extending rim may be compressed during forcible insertion of the cap within the cylinder;
and wherein the attachment comprises:
an interior circumferential lip that is caught by the rim of the cap when the cap is forcibly inserted within the cylinder, the compressed cap rim springing back to a larger diameter upon passing the lip and thereafter retaining the cap to, and within, the cylinder.

5. The tamper-proof security cover according to claim 3
wherein the cap
fits over the cylinder, and
has and presents an interior circumferential groove;
wherein the cylinder
has and presents an exterior circumferential groove;
and wherein the security cover further comprises:
a compressible ring fitting within the interior circumferential groove of the cap during its forcible placement over the cylinder so as to, when positioned oppositely to the exterior circumferential groove of the cylinder, pop into place within the grooves of both cap and cylinder, holding both together.

6. A method of protecting from tampering a nut or, equivalently, a bolt head appearing above a surface, the method comprising:
fitting between the nut or bolt head, as the case may be, and the surface both (1) a step washer having a side region of larger diameter disposed towards the surface, and (2) a hollow cylinder with an annulus at one end captured by the step washer so that the cylinder may rotate, and with its sidewall extending away from the surface;
tightening the nut, or equivalently the bolt, so as to leave the hollow cylinder captured by the step washer but still capable of rotation, while the sidewall of the cylinder enclosing all sides of the nut or bolt head, as the case may be;
forcibly compressing a hollow cap either tightly into or, equivalently, over the sidewall of the hollow cylinder so as to (1) thereafter rotate therewith, while (2) covering the nut, or the bolt head, as the case may be so as to thereafter prevent that the nut, or the bolt, should be loosened.
